(19) United States
(12) Patent Application Publication
(10) Pub. No.: US 2018/0180158 A1
(43) Pub. Date: Jun. 28, 2018

(54) VEHICLE-USED CRANKSET COMPOSITE STRUCTURE

(71) Applicant: D.MAG (KUNSHAN) NEW MATERIAL TECHNOLOGY CO., LTD., Suzhou (CN)

(72) Inventor: Jibing Tu, Suzhou (CN)

(21) Appl. No.: 15/453,983

(22) Filed: Mar. 9, 2017

(30) Foreign Application Priority Data
Dec. 23, 2016 (CN) 201611203069.X

(51) Int. Cl. F16H 55/30; B62M 9/00

(52) U.S. Cl. CPC F16H 55/30; B62M 9/00

(57) ABSTRACT

A vehicle-used crankset composite structure, comprising an inner ring piece made from a lightweight metal and a rigid tooth ring having a high wear-resistance and heat-resistance; a first joint surface is disposed on the inner ring piece; an inner ring hole is provided in the middle of the tooth ring; a second joint surface is disposed on the tooth ring; through welding the second joint surface to the first joint surface, the inner ring piece can be fixed into the tooth ring, and the inner ring hole of the tooth ring can be covered by the inner ring piece; according to the present invention, the integrality of the crankset can be greatly improved, achieving a lightweight structure and a high rigidity of the tooth portions.

### TECHNICAL FIELD OF THE INVENTION

The present invention relates to the technical field of vehicles, and more particularly, to a vehicle-used crankset composite structure.

### BACKGROUND OF THE INVENTION

A bicycle is a lightweight vehicle that is human-powered and pedal-driven. The drivetrain begins with pedals which rotate the chain and the crankset, enabling the wheels to rotate to move the bicycle forward. In the prior art, the bicycle crankset is integrally molded, and the molding material is usually made of hard iron. Along with the trend of lightweight design. Traditional iron-made cranksets are gradually being replaced by the crankset made from aluminum alloy.

Although aluminum alloy has a light weight, it is less durable than traditional iron cranksets. Furthermore, the fatigue performance of aluminum alloy is far lower than steel. A steel-made crankset can bear an infinite cyclic load. However, the fatigue limit of aluminum alloy is near zero, meaning that a very small cyclic load can damage the crankset made from aluminum alloy. During the movement, the point where the tooth portions of the crankset and the bicycle chain are engaged can easily be worn off. Consequently, the functional life of the crankset can be sharply decreased if the rigidity and the wear-resistance of the tooth portions are not high enough.

Thus, keeping the high rigidity and wear-resistance of the tooth portions as well achieving a lightweight crankset structure are urgent problems that need to be solved for those skilled in this field.

### SUMMARY OF THE INVENTION

The purpose of the present invention is to solve the shortcomings in the prior art, and provide a vehicle-used crankset composite structure.

To achieve the above purpose, the present invention adopts the following technical solution:

A vehicle-used crankset composite structure, comprising an inner ring piece made from a lightweight metal. The inner ring piece is hollow-cored, and the inner surface of the inner ring piece is equally divided and extends to form a plurality of fixing portions in the radial direction. A first joint surface is disposed on the inner ring piece. The vehicle-used crankset composite structure further comprises a rigid tooth ring having a high wear-resistance and heat-resistance. A plurality of annular bodies is formed on the outer side of the tooth ring, and each annular body is formed between two tooth portions. An inner ring hole is provided in the middle of the tooth ring. A second joint surface is disposed on the tooth ring. Through fixing the second joint surface to the first joint surface via welding, the inner ring piece can be fixed into the tooth ring and cover the inner ring hole of the tooth ring.

In another aspect of the present invention, the vehicle-used crankset composite structure mainly comprises an inner ring piece made from a lightweight metal. The inner ring piece is hollow-cored, and the inner surface of the inner ring piece is equally divided and extends to form a plurality of fixing portions in the radial direction. A first joint surface is disposed on the inner ring piece. The vehicle-used crankset composite structure further comprises a tooth ring. A plurality of tooth portions is formed on the outer side of the tooth ring. An inner ring hole is provided in the middle of the tooth ring. A second joint surface is disposed on the tooth ring, which is welded to the first joint surface, enabling the inner ring piece to be fixed into the tooth ring to cover the inner ring hole of the tooth ring.

In another aspect of the present invention, the outer surface of the inner ring piece is provided with a first joint surface, and the inner surface of the inner ring hole of the tooth ring is provided with a second joint surface. The inner ring piece is fixed in the inner ring hole of the tooth ring. The first joint surface is fixed to the second joint surface via welding. The inner ring piece and the tooth ring are disposed in the same horizontal plane.

In another aspect of the present invention, a first joint surface is disposed on one side surface of the inner ring piece which faces towards the tooth ring. A second joint surface is disposed on one side surface of the tooth ring. The inner ring piece is stacked on the second joint surface of the tooth ring through the first joint surface. The inner ring piece is fixed to the tooth ring via welding.

In another aspect of the present invention, the first joint surface of the inner ring piece is disposed on a protruding step structure of the outer edge of the inner ring piece. A first engaging portion, which is disposed along the outer surface of the inner ring piece, is disposed at the point where the protruding step structure is located. The second joint surface of the tooth ring is disposed on a step structure which is located on the fracture surface of the inner ring hole. A second engaging portion, which is disposed on the second joint surface, is disposed along the inner surface of the tooth ring to correspond to the first engaging portion. The inner ring piece uses the first engaging portion to engage with the second engaging portion. The first engaging portion and the second engaging portion stay in the same horizontal plane, enabling the first joint surface to be conveniently fixed to the second joint surface via welding.

In another aspect of the present invention, the first joint surface is disposed on the outer surface of the inner ring piece. The first joint surface is equally divided and extends outward to form a plurality of the first locating portions. The second joint surface is disposed on the inner surface of the inner ring hole of the tooth ring. A second locating portion, which is inwardly recessed, is disposed on the second joint surface to correspond to the first locating portion. The first locating portion can be engaged with the second locating portion. The first joint surface is fixed to the second joint surface via welding, and the first locating portion is fixed to the second locating portion via welding, enabling the inner ring piece and the tooth ring to stay in the same horizontal plane.

Compared with the prior art, the present invention has the following advantages:

First, the present invention adopts an inner ring piece made from a lightweight metal, and a tooth ring having high rigidity and wear-resistance, effectively reducing the overall weight of the crankset. Meanwhile, the tooth ring, which is used to engage with the chain, is made from a material having high rigidity, wear-resistance and heat-resistance, greatly prolonging the functional life of propelling the chain. Furthermore, the tooth ring does not need to be replaced as frequently as the traditional art due to the improved rigidity; the users thus feel safe when using the present invention.

Second, the inner ring piece is fixed into the tooth ring via welding, enabling the inner ring hole of the tooth ring to be covered by the inner ring piece. Consequently, the intensity of the tooth ring can be greatly improved. Meanwhile, the traditional dismountable structure of the inner ring piece and the tooth ring is replaced by the welding structure of the present invention, effectively preventing the inner ring piece from falling out from the tooth ring. Thus, the integral reliability of the present invention can be further improved.

### BRIEF DESCRIPTION OF THE DRAWINGS

To clearly expound the present invention or technical solution, the drawings and embodiments are hereinafter combined to illustrate the present invention. Obviously, the drawings are merely some embodiments of the present invention and those skilled in the art can associate themselves with other drawings without paying creative labor.

FIG. 1 is an assembled schematic view of the first embodiment of the present invention.

FIG. 2 is an exploded view of the first embodiment of the present invention.

FIG. 3 is an assembled sectional view of the first embodiment of the present invention.

FIG. 4 is an exploded view of the second embodiment of the present invention.

FIG. 5 is an assembled sectional view of the second embodiment of the present invention.

FIG. 6 is an exploded view of the third embodiment of the present invention.

FIG. 7 is an assembled sectional view of the third embodiment of the present invention.

FIG. 8 is an exploded view of the fourth embodiment of the present invention.

FIG. 9 is an assembled sectional view of the fourth embodiment of the present invention.

### DETAILED DESCRIPTION OF THE INVENTION

Drawings and detailed embodiments are combined hereinafter to elaborate the technical principles of the present invention.

### Embodiment 1

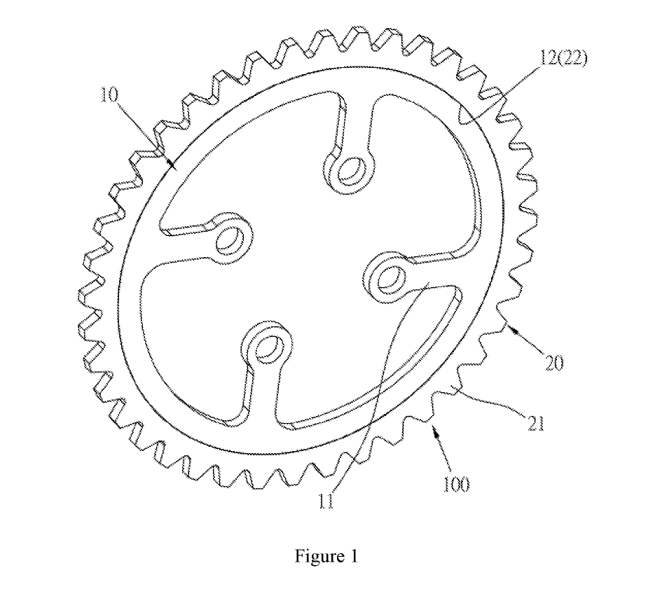

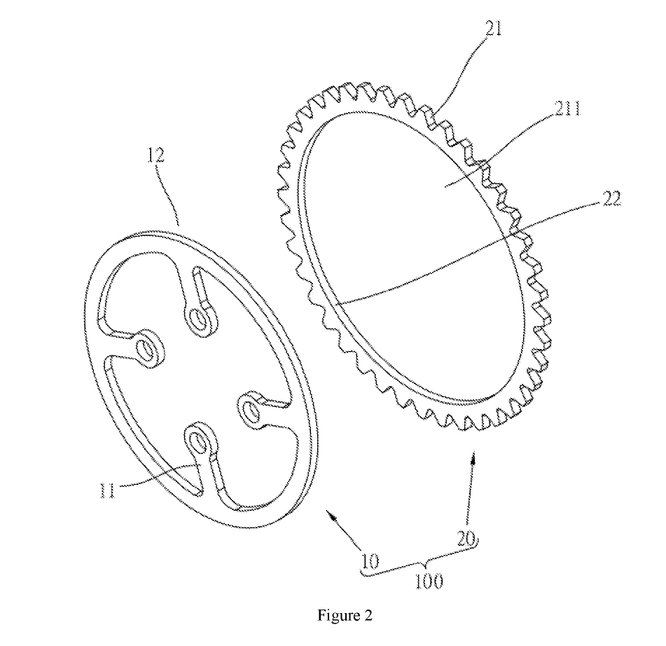

As shown in FIGS. 1-2, the present invention comprises a crankset 100. The crankset 1 further comprises a tooth ring 20 and an inner ring piece 10 which is fixed in the tooth ring 20. The inner ring piece is made from a lightweight metal, e.g., aluminum alloy, magnesium alloy or titanium alloy. The inner ring piece 10 is hollow-cored, and the inner surface of the inner ring piece 10 is equally divided, and extends to form a plurality of arm-like fixing portions 11 in the radial direction. The fixing portions 11 are used to fix the crankset 100 to the bicycle. A first joint surface 12 is disposed on the inner ring piece 10.

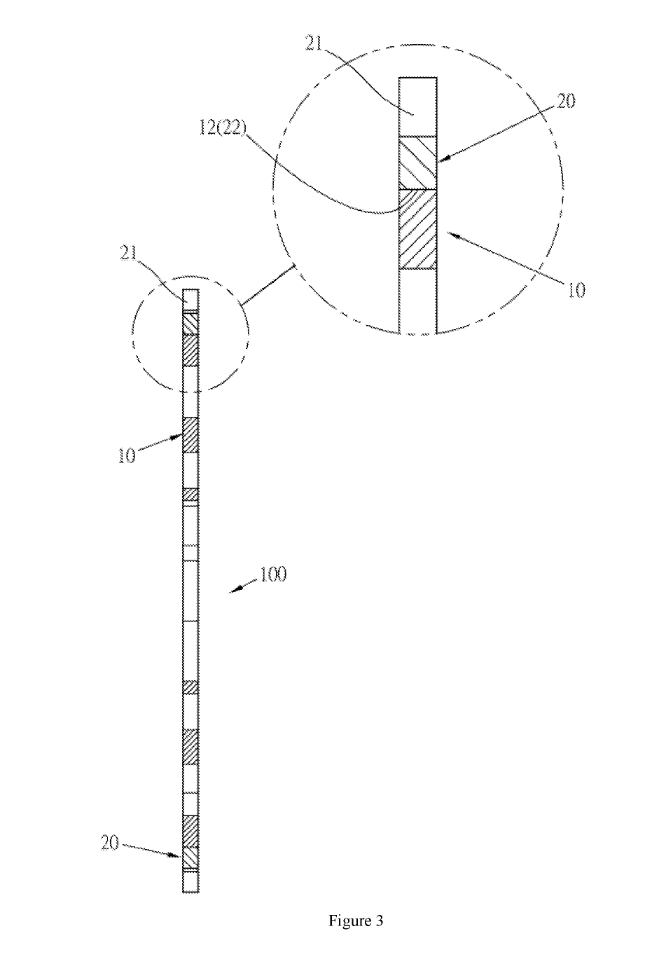

The tooth ring 20 is made from a rigid, heat-resistant and wear-resistant material, e.g., stainless steel, heat-treated steel, iron or metal coated with Teflon or other wear-resistant material, which can effectively strengthen the tooth ring 20 and improve its rigidity. A plurality of tooth portions 21 is formed on the outer side of the tooth ring 20. An inner ring hole 211 is disposed in the middle of the tooth ring 20. The inner surface of the inner ring hole is a second joint surface 22. When the tooth ring 20 and the inner ring piece 10 are assembled, as shown in FIGS. 2-3, the inner ring piece 10 is installed into the inner ring hole 211 of the tooth ring 20. The first joint surface 12 is fixed to the second joint surface 22 via friction welding method, enabling the inner ring piece 10 to cover the inner ring hole 211 of the tooth ring 20. Thus, the inner ring piece 10 and the tooth ring 20 stay in the same horizontal plane, forming the first type of crankset 100 of the present invention.

### Embodiment 2

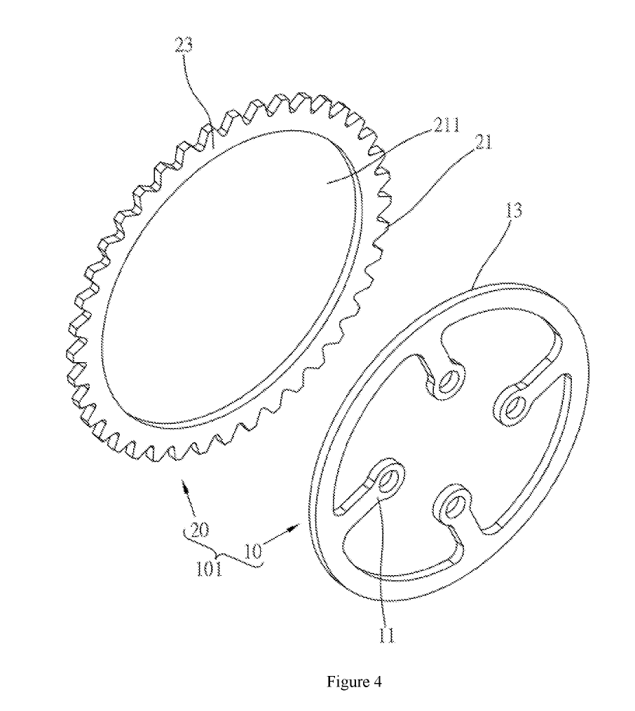

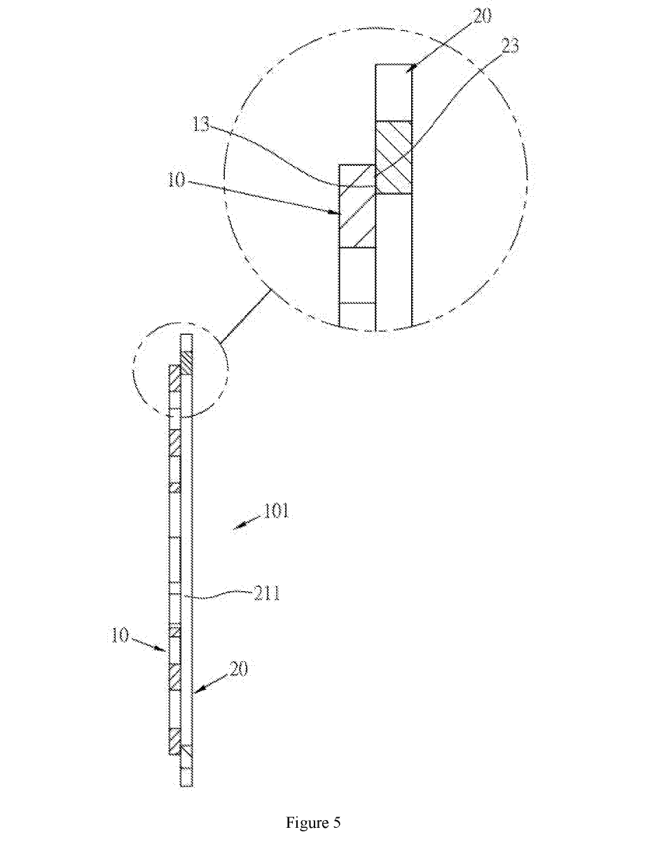

Another embodiment of the crankset 101 is shown in FIGS. 4-5. Differing from FIGS. 2-3, the location of the first joint surface 13 and the second joint surface 23 can be changed. The first joint surface 13 is disposed on the radial surface of one side of the inner ring piece 10 which faces towards the tooth ring 20, and the second joint surface 23 is disposed on the radial surface of one side of the tooth ring 20. The inner ring piece 10 is stacked on the second joint surface 23 of the tooth ring 20 through the first joint surface 13, which enables the inner ring piece 10 to be fixed to the tooth ring 20 via friction welding method, thereby forming the second type of crankset 101 of the present invention.

### Embodiment 3

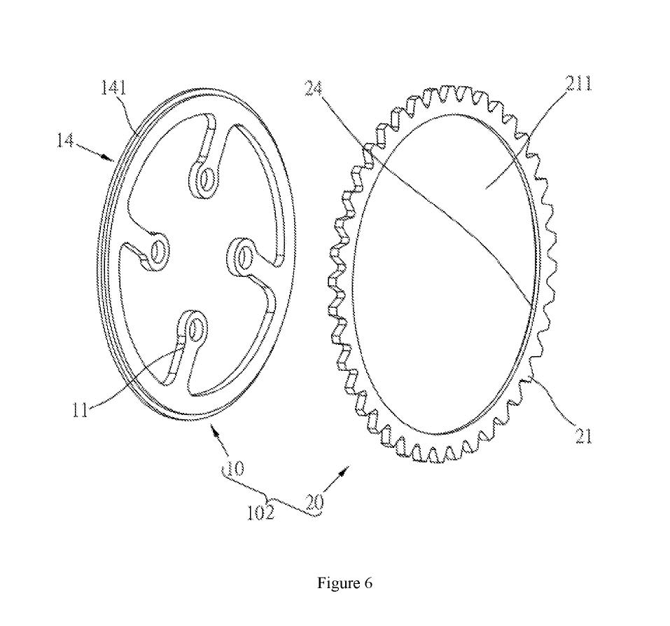

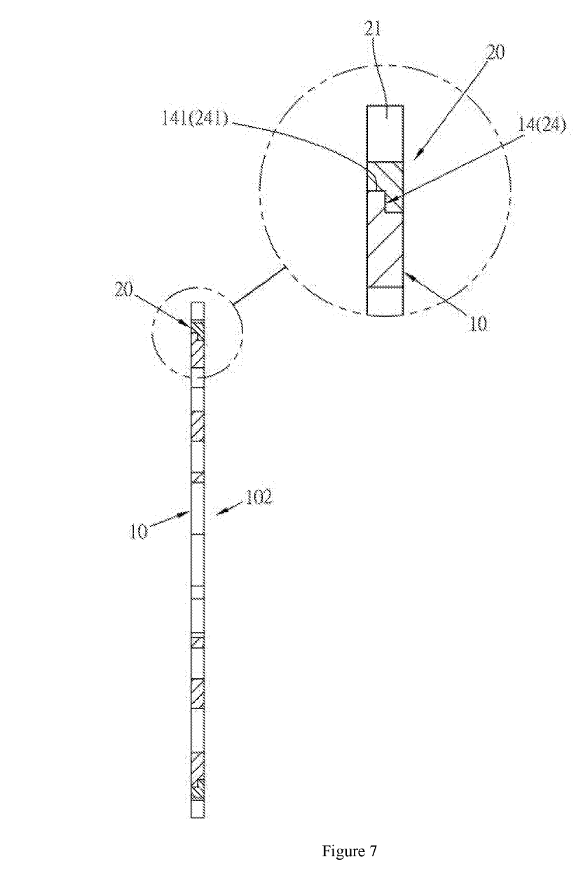

The third type of crankset 102 is shown in FIGS. 6-7, wherein the first joint surface 14 and the second joint surface 24 are jointed in a different way from the second embodiment. The first joint surface 14 is disposed on a protruding step structure of the outer edge of the inner ring piece 10. Consequently, the first joint surface 14 has a first engaging portion 141, which is disposed along the side surface of the inner ring piece 10. The step-like second joint surface 24 is disposed on the fracture surface of the inner ring hole 211 of the tooth ring 20. The second joint surface 24 forms a second engaging portion 241, which is disposed along the side surface of the tooth ring 20 to correspond to the first engaging portion 141. Thus, the inner ring piece 10 uses the first engaging portion 141 to horizontally abut on the second engaging portion 241, enabling the first joint surface 14 and the second joint surface 24 to be thoroughly engaged and further fixed via friction welding method. Consequently, the inner ring piece 10 is disposed in the inner ring hole 211 of the tooth ring 20, enabling the inner ring piece 10 and the tooth ring 20 to remain in the same horizontal plane. Through the engagement between the first engaging portion 141 and the second engaging portion 241, the precision of positioning and jointing the inner ring piece 10 and the tooth ring 20 can be improved, the contact area can be increased, and the reliability can be enhanced.

### Embodiment 4

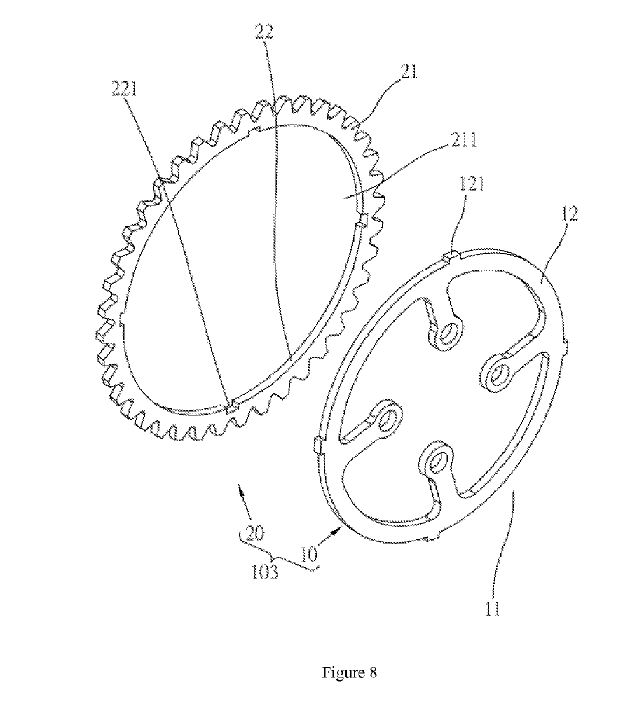

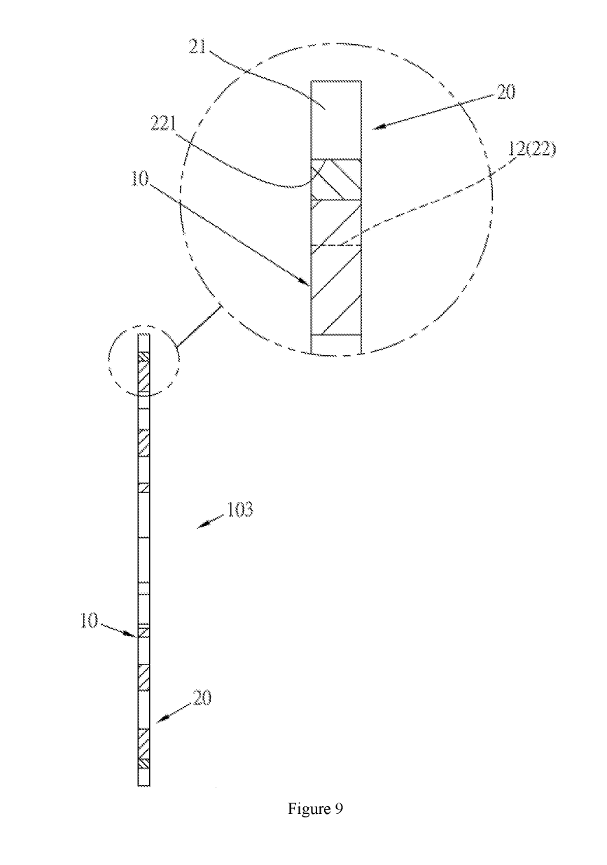

The fourth type of crankset 103 is shown in FIGS. 8-9. The inner ring piece 10 of the crankset 103 is shown in FIGS. 2-3, wherein the first joint surface 12 is formed on the outer side of the inner ring piece 10, and the outer side of the first joint surface 12 is equally divided and extends outward to form a plurality of the first locating portions 121. As shown in FIGS. 2-3, the second joint surface 22 is disposed in the inner ring hole 211 of the tooth ring 20. A second locating portion 221, which is inwardly recessed, is disposed on the second joint surface 22 to correspond to the first locating portion 121 of the first joint surface 12. Through the first joint surface 12, the inner ring piece 10 can enter into the second joint surface 22 of the tooth ring 20. According to the engagement between the first locating portion 121 and the second locating portion 221, the inner ring piece 10 can smoothly enter into the inner ring hole 211 of the tooth ring 20, thereby forming the contact between the first joint surface 12 and the second joint surface 22. Afterwards, the inner ring piece 10 and the tooth ring 20 can be fixed via friction welding method, enabling the inner ring piece 10 to remain in the same horizontal plane with the tooth ring 20. Under such circumstances, the engagement between the first locating portion 121 and the second locating portion 221 can effectively increase the contact area and improve the twisting force.

The previous descriptions are of preferred examples for implementing the invention, and the scope of the invention should not necessarily be limited by this description. The scope of the present invention is defined by the claims.

1. A vehicle-used crankset composite structure, comprising:
an inner ring piece made from a lightweight metal, wherein the inner ring piece is hollow-cored, and the inner surface of the inner ring piece is equally divided and extends to form a plurality of fixing portions in the radial direction, wherein a first joint surface is disposed on the inner ring piece; wherein the vehicle-used crankset composite structure further comprises:
a tooth ring, wherein a plurality of tooth portions is formed on the outer side of the tooth ring, wherein an inner ring hole is provided in the middle of the tooth ring, wherein a second joint surface is disposed on the tooth ring, wherein the second joint surface is welded to the first joint surface, wherein the inner ring piece is fixed into the tooth ring and covers the inner ring hole of the tooth ring.

2. The vehicle-used crankset composite structure of claim 1, wherein the outer surface of the inner ring piece is provided with a first joint surface, and the inner surface of the inner ring hole of the tooth ring is provided with a second joint surface, wherein the inner ring piece is fixed in the inner ring hole of the tooth ring, wherein the first joint surface is fixed to the second joint surface via welding, wherein the inner ring piece and the tooth ring stay in the same horizontal plane.

3. The vehicle-used crankset composite structure of claim 1, wherein a first joint surface is disposed on one side surface of the inner ring piece which faces towards the tooth ring, wherein a second joint surface is disposed on one side surface of the tooth ring, wherein the inner ring piece uses the first joint surface to stack on the second joint surface of the tooth ring, enabling the inner ring piece to be fixed to the tooth ring via welding.

4. The vehicle-used crankset composite structure of claim 1, wherein the first joint surface of the inner ring piece is disposed on a protruding step structure of the outer edge of the inner ring piece, wherein a first engaging portion, which is disposed along the outer surface of the inner ring piece, is disposed at the point where the protruding step structure is located, wherein the second joint surface of the tooth ring is disposed on the step structure, which is located on the fracture surface of the inner ring hole, wherein a second engaging portion, which is disposed on the second joint surface, is disposed along the inner surface of the tooth ring to correspond to the first engaging portion, wherein the inner ring piece uses the first engaging portion to engage with the second engaging portion, wherein the first engaging portion and the second engaging portion stay in the same horizontal plane, enabling the first joint surface to be conveniently fixed to the second joint surface via welding.

5. The vehicle-used crankset composite structure of claim 2, wherein the first joint surface is disposed on the outer surface of the inner ring piece, wherein the first joint surface is equally divided and extends outward to form a plurality of the first locating portions, wherein the second joint surface is disposed on the inner surface of the inner ring hole of the tooth ring, wherein a second locating portion, which is inwardly recessed, is disposed on the second joint surface to correspond to the first locating portion, wherein the first locating portion can be engaged with the second locating portion, wherein the first joint surface is fixed to the second joint surface via welding, and the first locating portion is fixed to the second locating portion via welding, enabling the inner ring piece and the tooth ring to stay in the same horizontal plane.
